(19) United States
(12) Patent Application Publication
(10) Pub. No.: US 2011/0311954 A1
(43) Pub. Date: Dec. 22, 2011

(54) MENTOR-GUIDED, COHORT-BASED POSTGRADUATE-LEVEL EDUCATIONAL PROGRAM FOR NON-TRADITIONAL STUDENTS

(76) Inventor: STEVEN R. BUCHHEIT, LUBBOCK, TX (US)

(21) Appl. No.: 12/820,789

(22) Filed: Jun. 22, 2010

(51) Int. Cl. G09B 19/00

(52) U.S. Cl. 434/219

(57) ABSTRACT

A set of candidates and one or more mentors can be enrolled in a cohort for a cycle. A set of loops can be conducted within the cycle. Each loop can end with a focus period. The focus period can be a continuous period of time that the cohort spends interacting face-to-face at a common geospatial location. Candidate performance can be evaluated at each loop. During this evaluation, a set of at least one of the candidates can be selectively permitted to continue to participate in the cycle while a different set is not permitted to continue. The evaluating can be performed based at least in part on candidate specific evaluation metrics provided by each of the one or more mentors. A postgraduate degree can be granted to each candidate responsive to and contingent upon successful completion of the cycle by the candidate.

### BACKGROUND

The present invention relates to the field of education and, more particularly, to a mentor-guided, cohort-based postgraduate-level educational program for non-traditional students.

Differences in expectations and approach exist between undergraduate and graduate level academic programs. Specifically, undergraduate programs largely ensure graduates have an adequately broad foundation (basic pre-requisites usually focused on in the first two years of a four year degree) and field specific knowledge base (higher-level courses that focus on field-specific details) to solidly perform in a real-world environment. Thus, a graduate of an undergraduate program should possess at least a baseline set of skills in a given field, and a sufficiently broad base of penumbral skills to be trainable for a variety of real-world occupations in the chosen field. Stated differently, a holder of an undergraduate degree should have sufficient knowledge and skills to make reasonable tactical decisions within a field of focus to satisfactory fulfill white-collar job functions in that field.

Postgraduate studies, by contrast, assume incoming students possess an adequate tactical foundation in a given field (or can quickly acquire such a foundation). Postgraduate studies (towards getting a master's, doctorate, or professional degree) expect that students are trained upwards from a tactical level to a strategic level in that field. At a strategic level, management of line employees, development of corporate level visions and long-term programs, and the like should be possible. This is the reason many postgraduate programs expect students to produce original research, including the writing and defense of a thesis or dissertation.

Postgraduate programs include ones for directly ingesting graduates from an undergraduate studies program as well as ones for in taking students with substantial experience within a field. Although there are postgraduate programs designed for students who already have substantial experience within a field, most traditional, accredited programs are geared towards students who have just finished their undergraduate studies, and do not yet have the advantage of real-world experience.

FIG. 1 (prior art) shows a conceptual representation of a conventional postgraduate academic program. In conventional academic programs, a gap 114 exists between a real-world environment 110 and an academic environment 112. Students 130 from the real-world 136 are assumed to have a foundational set of knowledge (undergraduate degree) and little else. The students 130 are treated as a clean slate 140, which is filled with absorbed knowledge 142 resulting from completion of a postgraduate program 120. Absorbed knowledge 142 is expressed herein as a set of discrete elements (shown as Element A, B, C, D, E, and F).

The program 120 itself consists of a set of courses 122, each designed to convey at least one knowledge element (Element A, Element B, Element C, and Element D shown as being conveyed) from a teacher 126 to a set of students 130 (which vary in identity from course to course, shown as different shapes within the program 120 graphic). Program 120 can represent any of a variety of different curriculums 152, with completion of a curriculum leading to a specific degree. A set of different options for courses may be defined for each curriculum, where options provide students 130 with choices, any of which will ultimately result in a degree specific set 144 of knowledge elements (Elements A-F) being absorbed.

In the traditional program 120, each course 122 is conducted as a scheduled class, which usually meets for a set duration (e.g., approximately an hour and a half) during a fixed period of a day, meeting multiple times a week for a period of a few months. Some of these courses 122 can be taken in parallel, others must be taken serially, assuming that one or more knowledge elements learned in an early course 122 is needed for a later one. During each course 122, teachers 126 push the defined set of knowledge 144 to students 130, who presumably have absorbed these knowledge elements (Elements A-D, for example) during the process of attending each course 122. The absorption and retention of knowledge elements is evaluated on a course-by-course basis by the teachers 126 of the courses 122 (i.e., grades per course 122 are given, where students 130 must at least possess a satisfactory grade to “pass” the course 122).

In a conventional academic environment 112, a baseline set of degree specific knowledge elements 144 is defined that is based on a theoretical model 150 of the real-world 136. The curriculum 152 upon which the offered program 120 is based is inherently flawed at least by the delta (e.g., gap 114) between the model 150 used in academic environment 112 and the true state of the real-world environment 110. Further, academic environment 112 presupposes that each incoming student 130 is a blank slate 140 lacking a complete set of post graduate knowledge 142, which needs to be trained into them. Environment 112 is tailored for a one-way conveyance of knowledge from teacher 126 to student 130. Additionally, time lines are reasonably static and fixed for a program 112, which is largely constructed as a “one-size-fits-all” approach to postgraduate training.

### BRIEF DESCRIPTION OF THE SEVERAL VIEWS OF THE DRAWINGS

FIG. 1 (prior art) shows a conceptual representation of a conventional postgraduate academic program.

FIG. 2A shows a diagram for a postgraduate-level educational program for non-traditional students in accordance with embodiments of the disclosure.

FIG. 2B shows a different perspective of the disclosed program in accordance with one contemplated embodiment.

FIG. 2C shows a positioning of program knowledge systems relative to corporate knowledge systems and academic knowledge systems in accordance with an embodiment of the disclosure.

FIG. 3 is a diagram showing a cycle of the program in accordance with an embodiment of the disclosure.

FIG. 4 shows a flow chart of a method of a cycle from the perspective of a mentor in accordance with an embodiment of the disclosure.

FIG. 5 shows a flow chart of a method of a cycle from the perspective of a candidate in accordance with an embodiment of the disclosure.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

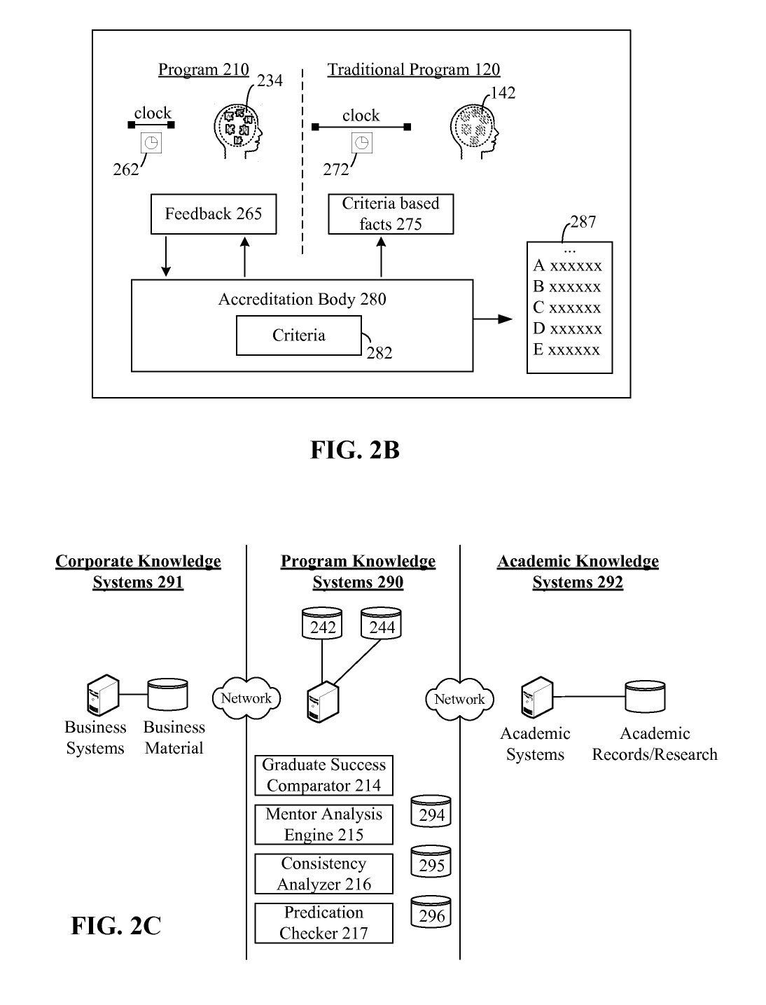

Turning to the figures, FIGS. 2A, 2B, and 2C show diagrams for a postgraduate-level educational program 210 for non-traditional students in accordance with embodiments of the disclosure. In the non-traditional academic program 210, a cohort 220 is established, which includes candidates 222 and mentors 224. Candidates 222 are students able to earn a postgraduate degree upon successful completion of the program 210. Mentors 224 include teachers as well as business leaders participating in one or more phases (e.g., loops) of the program 210.

Unlike conventional academic environments 112 that presume incoming students 130 enter a program as a clean slate 140, the disclosed program 210 assumes that candidates 222 enter with a level of knowledge 232. This level of knowledge 232 will vary from candidate 222 to candidate 222. The initial knowledge 232 is analyzed on an individual basis to determine strengths and weaknesses of each candidate 222. Cohorts 220 are specifically formed groups configured to take advantage of this initial knowledge 232, which is shared among other candidates 222 and mentors 224. That is, cohorts 220 are specifically constructed to create a balanced, complementary set of strengths and weaknesses. Members 222, 224 of the cohort 220 are expected to refine and increase the knowledge of each other. That is, all members 222, 224 are active participants in the program 210 and information and knowledge is explicitly intended to flow bi-directionally (mentor-to-candidate as well as candidate-to-mentor) as well as laterally (candidate-to-candidate). A candidate's knowledge 234 upon successful completion of the program 210 is expected to have been expanded, which results in a more well-rounded and refined knowledge base (knowledge set 234) than the candidate previously possessed (knowledge set 232). The refined knowledge set 234 represents a proficiency level sufficient for granting a postgraduate degree to the candidate 222, who has completed the program 210.

A number of significant changes between program 210 and a traditional one 120 are notable. First, it is assumed that candidates 222 participating in the program 210 have value to add to the process. That is, the candidates 222 should be non-traditional students having real world experiences and practical knowledge derived on the job (or should be people with a capability to translate existing skills from another expertise area to a new field). These experiences translate to the initial knowledge set 232, which is shared with the cohort 220. The knowledge set 232 is not a static one, it is to be adapted and transformed throughout the program 210.

The program 210 is designed so that it may be taken while a candidate 222 is still engaged in the workplace. This is not necessarily a requirement. In one embodiment, candidates 222 can be accepted who are not working concurrent with program 210 involvement. The gap (e.g., gap 114) between an academic environment 112 and the real-world environment 110 is reduced/eliminated by the program 210. Candidates 222 are to bring real world 250 problems and their applicability to program 210 specifics to the mentors 224, who are to dynamically adapt the content of the program 210 and/or structure tasks to help resolve the problems (or insights) experienced in the real world 250. This is intended to encourage candidate 222 participation and even corporate (from real world 250) sponsorship of the program 210, as practical improvements are quickly realized by the candidates 222, which can be readily adapted to their real-world 250 occupations. Additionally, one or more of the mentors 224 can be “adjunct professors” or guest speakers (referred to hereafter as adjunct mentors), who operate in the real-world environment 250 (as opposed to an academic one). These adjunct mentors 224 can include past candidates 222 who completed the program 210, can include future candidates 222 of the program 210, can include business executives who manage one or more candidates 222, and/or can include volunteers (paid or otherwise) for the program 210.

Unique time constraints exist on the candidates 222 and mentors 224, who often have areas of primary responsibility that could result in a scheduling conflict with a traditional program 120. Program 210 is designed to compensate for anticipated challenges experienced by non-traditional students in a manner that minimizes complications. Much of the time spent in the program 210 is done without explicit scheduled participation times or class sessions. Instead, a series of concentrated interactions (e.g., end-loop focus period 252) are required. These focus periods 242 can be a continuous week (or other such extended time period), during which the entire cohort 220 interacts with each other in a face-to-face setting. Non-traditional students can schedule their vacation time within a standard job structure to permit attendance during the focused period 252. Similarly, a company encouraging participation in the program 210 may consider the period 252 of concentrated interaction a business trip, a business training off-site, and the like, which would have no negative ramifications on a candidate's 222 vacation time.

The program 210 can be a cyclic one, comprised of a quantity of repeating iterations. Stated differently, a series of loops occur, in which each loop is ended by the end-loop focus period 252. After three (although this number can be modified and still be within scope of the disclosure) loops, a cycle ends, and candidates 222 can selectively graduate. The program 210 is implemented in cycles, as different cycles (one cohort 220 per each cycle) can run asynchronously to other cycles. Thus, unlike traditional programs 120 where all courses within a semester have a designated start and end time, which are equivalent for each course, different cycles can have tailored time horizons, which are able to be customized to the needs of the cohort 220 participating in the cycle. This flexibility and customization on a cycle-by-cycle basis can be significant, as many of the mentors 224 and candidates 222, especially many of the most desirable ones, can have significantly different needs from candidates 222 and mentors 224 of other cycles.

Additionally, the end-loop focus period 252 can be timed for a specific event, which may not be associated with the program 210. For example, the event can occur in a time and place related to the program 210, yet be a “real-world” event, which represents a significant learning advancement opportunity for the cohort 242. For instance, for an international business program (one variant of program 210), the focus periods can be hosted within different countries and can focus on events specific to an aspect of international business, such as the World Trade Organization's World Economic Forum, and the like.

In one contemplated embodiment, each loop (or at least a portion of the loops) can focus on a case study, and the end-loop focus periods 242 can occur at a time and place representing the culmination of that case study. The case study can be retrospective, focusing on an event that already occurred, which is the traditional means for conducting case studies in an academic environment (Harvard Business School is, for example, considered to follow a case study-focused curriculum). The case study can also be a predictive one, for an on-going real-world 250 problem/circumstance, with which the cohort 220 is integrally involved.

Turning back to a loop, an iterative process can occur before an end-loop focus period 252. During this time, a set of tasks 240 can be established by mentors 224 for the candidates 222. These tasks 240 can be group based or customized for the needs of a specific candidate 222. Electronic facilitation tools can be used to enable collaboration among candidates 222 and mentors 224. For example, tasks 240 can be scheduled and updated in repository 242. Additionally shared resources 244 can exist which are accessible by candidates 222 and mentors 224. These resources can include topic lectures (pre-recorded), sample exercises, candidate 222 provided notes, and the like. The resource repository or corpus (data store 244) is expected to grow during the execution of a loop, where the material of the corpus remains available to other cycles thereafter. Thus, the corpus of resources 244 can be a constantly expanding one, which can be groomed, pruned, and/or otherwise updated over time. Special permissions can be given to ensure that the information of repository 242 and/or data store 244 are accessible via a network 246 connection by the cohort 220. Different levels of permission can be established to ensure information confidentiality is maintained as needed, which can be a significant consideration due to real-world 250 content potentially being used by a cohort 220 during a cycle.

The end-loop focus period 252 can represent a decision point, where a set of the candidates 222 (and optionally mentors 224) may continue with the cycle, another set may be dropped from the program 210, a set of the candidates 222 (and optionally mentors 224) may be referred from the program 210 to a more traditional academic program 120. Further, adjustments 244 are made at the end of a loop, to help focus each candidate 222 on their own needs (e.g., shortcomings in the desired knowledge set 234). The adjustments 244 can change the resources (242, 244) accessible by the cohort 220, the tasks 240 required of the cohort 220 or individual candidates 222, etc.

FIG. 2B shows a different perspective of the disclosed program in accordance with one contemplated embodiment. The non-traditional program 210 has intense, focused interactive periods 242, as opposed to more spread out periods of a traditional program 120. Thus, the “in class” time is highly condensed in program 210 in comparison to time consumed by traditional program 120.

This is a win-win situation for the program 210 provider and the non-traditional students (candidates 222). The program 210 provider consumes fewer fixed resources (e.g., dedicated classroom space), which can result in significant cost reductions. The students (candidates 222) receive an educational curriculum more tailored to their situation, as non-traditional students often have a full-time job and its accompanying demands. Despite the condensed nature of the interactive time 262, sufficient face-to-face time occurs to satisfy standards of accreditation bodies 280. In other words, the program 210 is an improvement over an accredited, traditional class-room experience and is not a remote learning endeavor.

Further, the knowledge set 234 resulting from the program 210 is anticipated and is designed to be stronger than the knowledge set 142 acquired from the traditional program 120. This difference is due to maximizing assets (leveraging the knowledge 232 of each candidate) while focusing on shortcomings. Further, candidates 222 are treated similar to self-motivated, informed adults, who are attempting to identify their strengths and improve upon their weakness. The candidates 222 are given all the tools (e.g., repository 242, 244) needed to prepare for a focus period 252 and are expected to prepare adequately. This is contrasted with a traditional approach of program 120, which attempts to “test in” knowledge that is directed generally to a class of students. Effectively, in a traditional program 120 no assumptions are made as to a student's ability to learn content given a set of resources.

The disclosure emphasizes that while some individuals will benefit from the highly guided structure of a fixed class (program 120); this is not the case for a vast majority of non-traditional students (e.g., candidates 222). Non-traditional students often feel bored when confronted with knowledge (144) that they already possess (part of knowledge set 232). Worse, aggressive situations can arise when existing knowledge (set 232) of these nontraditional students (candidate 222) is greater than that of a teacher (e.g., 122) used to lecturing about a subject. Many such teachers 126 are not trained to leverage the knowledge of students 130, to the benefit of all involved. The time 272 consumed on already mastered content can account for a significant part of the interactive time spent in a traditional program 120. This portion of time 272 is non-optionally spent when teaching many non-traditional students (candidates 222), although it may be necessary for some students 130 lacking the real world 250 experience and hard-earned knowledge.

Indeed, existing knowledge 232 is often seen as a barrier for learning course 122 materials, often laden with misperceptions due to the gap 114 between academic modeling of phenomena and the real-world environments 110, 250 being modeled. Not only is this ill-spent time, but it is also a missed opportunity to the academic communication, one where knowledge 232 of the students (candidates 222) can be used to minimize the gap 114 to the betterment of all concerned.

Stated differently, many of the candidates 222 have shown an ability to compete, perform, and even excel in a real-world environment 250. This requires a self-commitment and an ability to absorb lessons and knowledge on one's own, applying them to real-world 250 challenges. These same people (candidates 222) may lack a complete infrastructure or foundation of knowledge (knowledge set 234), which a systemic program (e.g., program 210 or 120) can provide. This lack can prevent these candidates 222 from excelling in the business world (250) and can inhibit the candidates 222 from achieving their potential. At the same time, the knowledge set 232 that permits candidates 222 to succeed in the business world (e.g., world 250) often represents un-captured truths (un-captured by academia circles) and/or targets flaws in existing academic models. Mentors 224 can help direct and guide this knowledge 232 into formal artifacts and structures of academics, providing strong gains to all 220 involved. Effectively, a feedback loop is established that permits the learning structure of the program 210 to be a reinforcing system that is self adjusting.

Turning back to FIG. 2B, the criteria 282 for granting a postgraduate degree represents a minimum quality benchmark of skills believed to prepare graduates for real-world tasks. Presently, the criteria 282 is generated by an accreditation body 280 (or approved by one), which are embraced by accredited programs 120, as a curriculum 287 to be taught. This curriculum 287 is taught as a set of criteria based facts 275 (e.g., Element A, B, C, D, E, and F, for example) injected into the course lectures of program 120. Periodically, these elements evolve and change. The rate of this change is substantially less than that of the marketplace. The business marketplace (of real world 250), by nature of an open economy that rewards innovations and sound business practices, must self-correct at a rapid rate, which is trailed behind slowly by more rigorous and risk-adverse academic circles.

The program 210, unlike traditional program 120, can by its nature provide feedback 265 to the accreditation body 280, which can be used to help adjust the criteria 282 upon which program 210 and traditional program 120 are formed. This feedback 265 is encouraged as candidates 222 and mentors 224 within the cohorts 220 work together towards a common goal of increased understanding of a subject. Thus, program 210 represents a special case within academics with significant advantages realized by the academic community (including accreditation body 280) and the candidates 222. In this sense, program 210 represents a change of focus during postgraduate studies. The change is from assuming students 130 have little to provide an academic institution (other than a canvas to which knowledge can be written) to a recognition that student (candidate 222) possesses knowledge (knowledge set 232) that should be leveraged to effectuate change within the academic institution. This change can propagate to all types of programs, raising academic results across the board.

In other words, a significant portion of the candidates 222 of the program 210 can be selected (many candidates 222 may even receive scholarships based on existing knowledge sets 232) to improve the learning environment provided to all. Since these candidates 222 have practical, real world knowledge 232, which is quantified and respected (even utilized), by the mentors 224, curriculum improvements 287 and adjustments are inevitable (as opposed by being an afterthought or an onerous task performed to update course material).

The fundamental concept at play is that “truths” properly employed within the real-world 250 environment result in a competitive advantage. The competitive advantage translates into business success. Similarly, “inaccuracies” or falsehoods used to direct business activities within the real-world environment 250 result in a competitive disadvantage. This disadvantage translates into business shortcomings. Unfortunately, the actual elements from which success is derived are often misunderstood by the actors involved. This is an area where academic analysis and rigor are highly advantageous to the business world (250). Once positive elements of success are determined, they can be recorded within academic papers and can be used to expose flaws in existing academic papers. Thus, program 210 represents a means to strengthening the coupling between practice (real-world business) and theory (academics) to the betterment of both.

FIG. 2C shows a positioning of program knowledge systems 290 relative to corporate knowledge systems 291 and academic knowledge systems 292. FIG. 2C acknowledges that the details described for the program 210 can be data driven ones. That is, the successes and failures of the program 210 can be constantly monitored by analyzing extracted data points. Successes can be highlighted and focused upon, which adjusts program 210 specifics.

In one sense, the program knowledge systems 290 can be a buffer between corporate knowledge systems 291 and academic knowledge systems 292, which works to bridge gaps (e.g., gap 114) between the two. For example, various cycles can be focused on real world 250 business problems, which require insight and even access into actual business material and business systems (knowledge systems 291). For example, a cohort 220 can be solicited to provide an analysis of a business problem (experienced by corporate knowledge systems 291). This analysis can result in a defining of tasks (data store 242) and a development of resources 244, which are used within the loop. Confidential information can be included, which must be sanitized before the results can be placed within the corpus for posterity, which is used by the program knowledge systems 290.

A portion of the tasks 242 preformed by cohorts 220 can be predictive ones, designed to apply academic records and research to a real world problem (e.g., possibly at behest of a business seeking advice/analysis). These predictions 295 can be stored and their accuracy checked over time. Prediction checker 217 can be used during this process.

Similarly, a consistency analyzer 216 program can be used to determine whether academic records/resources are consistent with business material and approaches. Deltas can be identified and can be the focus of tasks 242 designed to resolve the apparent discrepancies by either modifying business practices to match academic knowledge or to adjust academic knowledge/research models to reflect real world 250 practices. The larger the disconnect between the two, the less significant academic research can be for practical business decisions.

Additionally, a composition of the program 210 is constantly monitored and adapted. These adaptations can be based on feedback (database 296) and historic information (database 294). For example, a graduate success comparator 214 can track performance of graduates of the program 210 versus performance of graduates of a traditional program 120. Comparator 214 can also compare graduates of the program 210 versus similarly positioned individuals who did not participate in the program 210. One measure of the success of the program can be based on superior performance of its graduates. Thus, differences in any given cycle that resulted in highly successful graduates (versus cycles having less successful graduates) can be analyzed and used to change program 210 specifics.

Further, one or more automatic tools can be used to locate, determine, and evaluate the performance of mentors 224. The mentor analysis engine 215 can, for example, track future performance of mentors 224, which is time divided into a pre-program 210 phase and a post-program 210 phase to determine benefits derived from mentors 224 as a result of the program 210 participation. Similar analysis can be performed against academic standards of an academic institution based on program 210 involvement. Existing pattern matching, statistical analysis, neural networking, learning algorithms, and similar technologies can be used when implementing the program knowledge systems 290. It should be appreciated that the metrics and performance results maintained by system 290 can be valuable in proving program 210 viability to an accreditation body 280, a government grant handling entity, and/or a university system participating in the program 210.

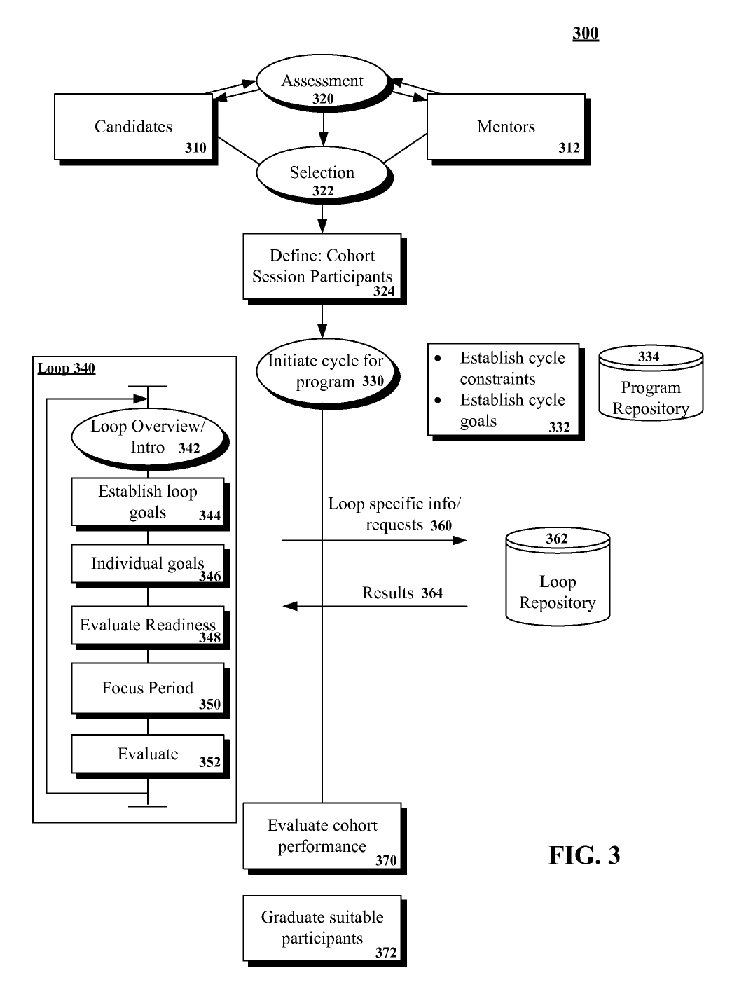

FIG. 3 shows a diagram 300 showing a cycle of the program in accordance with an embodiment of the disclosure. Before a cycle can begin, candidates 310 and mentors 312 must be identified. Both candidates 310 and mentors 312 are assessed 320 to determine their strengths, weaknesses, knowledge set 232, and suitability for the program 210. A selection process 322 can determine which of the candidates 310 and mentors 212 are to be issued invitations to join a cohort 324. Since a cohort 324 can be a balanced set of individuals, the desired characteristics of candidates 310 and mentors 312 can vary from cycle to cycle of the program.

After cohort participants have been defined, a cycle of the program can be initiated 330. This initiation can involve establishing cycle constraints, goals, and other cycle-specific factors. These factors can be recorded in the program repository 334.

For each cycle, multiple loops 340 can be conducted. A loop overview or introduction 342 can be provided at a loop's beginning. Loop-specific goals can be established 344. Then individual goals 346 or candidate-specific goals can be established for the loop. During a tasking period (e.g., tasks 240), a readiness level of the candidates 222 and mentors 224 can be assessed. When one or more candidate 222 fails to appropriately prepare for the focus period 350 (e.g., period 252), he/she may not be permitted to participate. This assessment can be based on whether the individual goals 346, such as pre-period goals, have been satisfied. Similarly, an entire cohort 220 can be evaluated as to whether it is ready to enter the focus period 342, and if the evaluation is not indicative of readiness, the focus period 342 can be delayed.

Once all remaining cohort 220 members are ready and when the time horizons for the focus period 350 occur, the focus period 350 can begin. Results from the focus period 350 can be recorded and individual assessments can be conducted in the evaluation phase 352. Results of this phase can cause adjustments 254, such as one or more candidates 222 (310) being removed from the program 210 and/or transferred to a more traditional program 120.

In one embodiment, a statistic constraint can be established where only a portion of the candidates 222 are permitted to continue after the evaluation phase 352. In other words, a curve can be imposed, where a lowest performing percentage of the candidates 222 as defined by the mentors 224 (or other criteria) are not permitted to continue. Thus, a competitive environment is automatically established, which can be strictly enforced. This type of constraint can add substantially to the prestige with which graduates of the program 210 are held. When implemented, the competitive nature of the program can be analogous to the competitive nature of a typical business environment.

For each completed loop, loop-specific information and requests can be conveyed to a loop-specific repository 362 and results 364 can be acquired from the same. The repository 362 can thus be a collaborative space where candidates 222 and mentors 224 can share information. In one embodiment, the program repository 334 and the loop repository 362 can be part of the resource corpus data store 244.

After all loops of the cycle are completed, the cohort performance 370 within the cycle can be evaluated. This evaluation can be based on feedback from candidates 222, the mentors 224, by independent observers (possibly participants in the focus period 252), by program 210 administrators, and the like. Additionally, at the end of the cycle, suitable participants can graduate 372.

In one embodiment, not all candidates 222 that complete the set of loops 340 will graduate. The number of graduates permitted within a cycle can be based on an imposed statistical curve. This curve can even vary based upon performance of the cohort, as evaluated in step 370. Thus, when a cohort performs better than average, leeway to graduate more candidates 222 can be granted. Similarly, when a cohort 220 performs poorly, fewer than a baseline level of candidates 222 may be permitted to be graduated, in step 372.

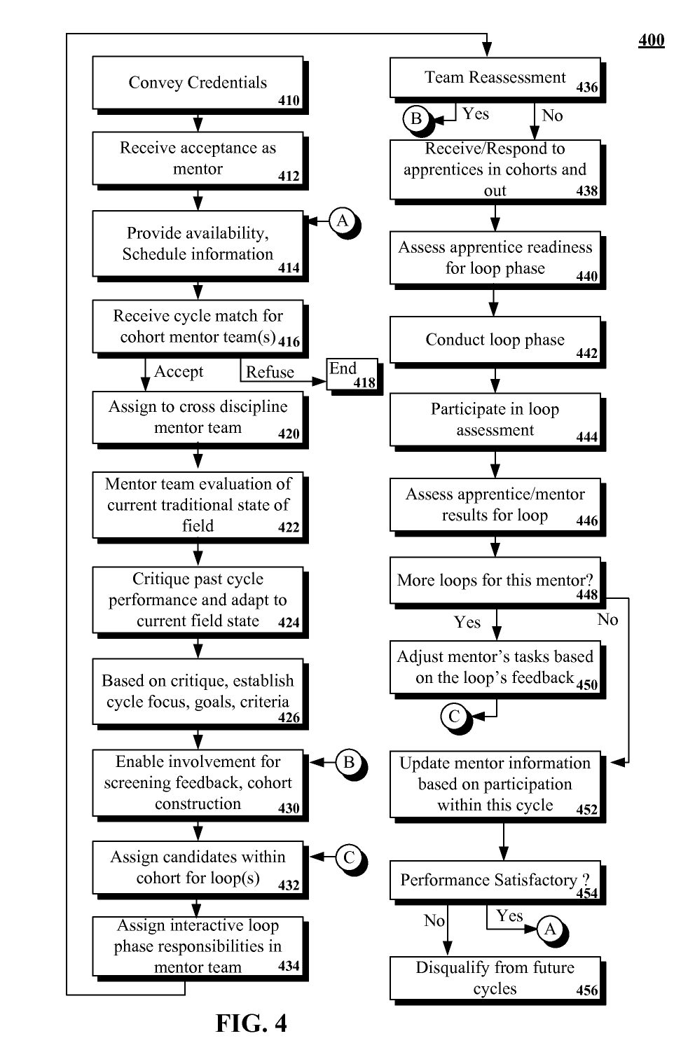

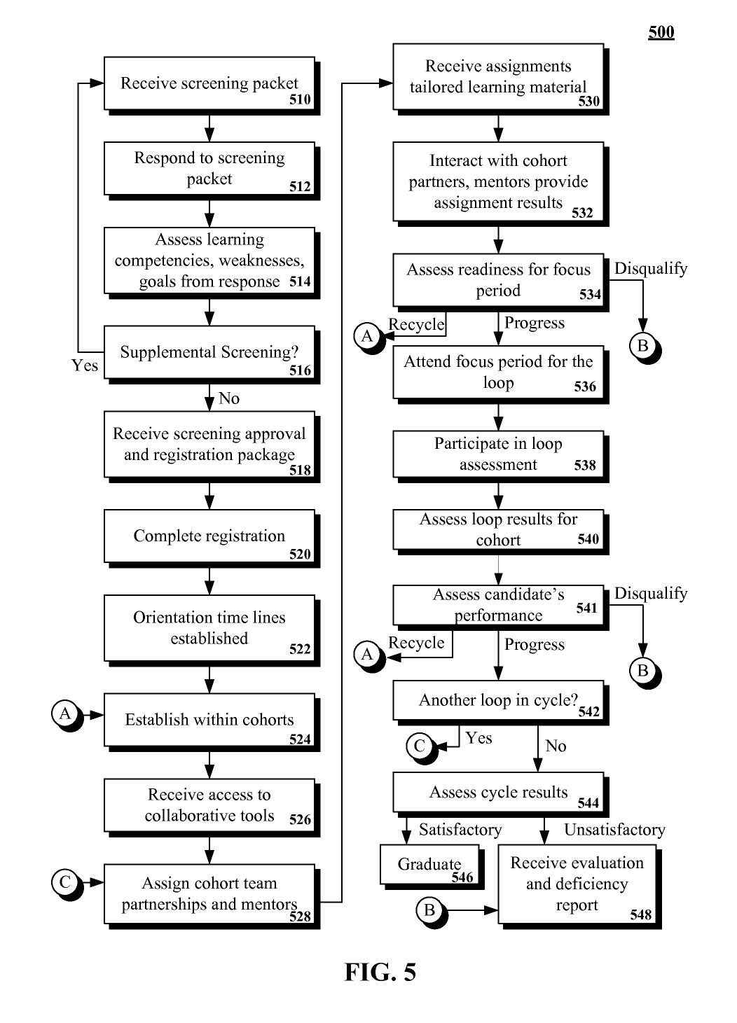

Perception of the overall process of the cycle can be different from different perspectives. That is, experiences of mentors 224 can vary from those of the candidates 222. Diagram 400 of FIG. 4 shows a flow chart of a method 400 of a cycle from the perspective of a mentor in accordance with an embodiment of the disclosure. FIG. 5 shows a flow chart of a method 500 of a cycle from the perspective of a candidate in accordance with an embodiment of the disclosure.

Method 400 can begin in step 410, where a potential mentor (an applicant for becoming a mentor) can convey their credentials to a program administrator. In step 412, the mentor can receive acceptance to participate in the program or not. An accepted mentor can provide availability and scheduling information. Based on this information, the mentor can be matched to a specific cohort and cycle, as shown by step 416. If the mentor refuses to participate with the cohort, the method can end 418. The mentor's information can be retained on file and used for future matches in one embodiment. In another embodiment, if a mentor refuses matches too many times, his/her information can be modified so that the mentor is disfavored in future matches.

Should a mentor accept a match, that mentor can be assigned to a cross discipline mentor team 420. The entire mentor team can evaluate a current traditional state of the academic field, for which the cycle is part of, as shown by step 422. The mentor team can also critique past cycle performance records and make adaptations for the current state of the field, as shown by step 424. Based on the critique, a cycle focus, goal set, criteria, and the like can be established, as shown by step 426.

Mentors can then involve themselves in the screening process for selecting candidates for the cohort, as shown by step 430. In one embodiment, specific candidates of the cohort can be assigned to specific mentors, where the assigned cohort is considered an apprentice. This assignment can be performed within the cohort, as shown by step 432. The assignment of apprentices to a mentor can be for a single loop, for multiple loops, or for an entire cycle depending on the situation.

In step 434, interactive loop phase responsibilities can be assigned to the various mentors of the cohort. The set of mentors within a cohort can be referred to as the mentor team. Once all these assignments are made, a team reassessment of the cycle and cohort can be performed, as shown by step 436. If reassessment is indicated, the cohort can be reconfigured, as shown by looping from step 436 to step 430.

Once a team has been finalized, mentors can respond to questions from candidates. These candidate can be ones that are members of the cohort and ones that are not, as shown by step 438. In step 440, apprentice readiness for the loop phase can be assessed. In step 442, the loop phase of the cycle can be conducted. The mentor can participate in the loop phase, and can assess participant performance during and after the phase, as shown by step 444. Candidates can also provide loop assessment feedback. In step 446, mentor and/or apprentice results for the loop can be assessed.

A mentor may participate in an entire cycle, or may participate in a subset of the loops of the cycle. When the mentor is to participate in additional loops, the method can proceed from step 448 to step 450. In step 450, the mentor's role within the cycle and other loop-specific settings can be adjusted based on the current loop's feedback. The method then proceeds from step 450 to step 432, where new candidates for the next loop can be assigned to the mentor.

If the loop was the last one of the cycle for the mentor, the method can proceed from step 448 to step 452. In step 452, mentor information maintained for the program 210 can be updated based on the mentor's participation in the cycle. In step 454, the mentor's performance can be evaluated. When this performance is satisfactory, the mentor can be invited to participate in future cycles, shown by progressing from step 454 to step 414. When the mentor's performance was not satisfactory, the mentor can be disqualified from future cycles, as shown by step 456.

As noted, FIG. 5 shows a program cycle from a participant's perspective. Method 500 shown in FIG. 5 can begin in step 510, where a candidate can receive a screening packet. In step 512, the candidate can complete the packet questions and return the responses. In step 514, the learning competencies, weaknesses, and goals can be assessed for the candidate from the responses. Zero or more supplemental screening sessions can be performed, as shown by step 516. The screening sessions can take many forms to assess a candidate's suitability for participation in the program and/or a specific cycle of the program as well as to make selections for granting scholarships to candidates. Screening sessions can include, for example, supplemental questions asked by mentors or can include sample exercises to be completed by the candidates. Screening sessions can also include interviews (face-to-face, teleconference, Web conferencing, etc.) between the candidate and mentors and/or program administrators.

In step 518, the candidate can receive screening approval or disapproval. When approval is received, the candidate may complete registration in step 520. In step 522, orientation time lines can be established and scheduled. In step 524, the candidate can be selected to join a cohort for a cycle of the program. Upon selection, the candidate can receive access to collaborative tools, as shown by step 526. In step 528, cohort team partnerships and mentors can be assigned.

Assignments, tasks, and other loops, cycles, cohorts, and/or candidate-tailored materials can be received by the candidate, as shown by step 530. Many of these assignments can require completion within mentor established time lines. Assignments can also require cooperation and collaboration with one or more candidates within the cohort. The members of the cohort can interact for many reasons within the loop in a directed or undirected fashion, which is represented by step 532.

In step 534, an assessment of the candidate's readiness for participating within the focus period of the loop can be performed. The candidate can be disqualified, which can result in the candidate receiving an evaluation and/or deficiency report, as shown by step 548.

The candidate can also be recycled, which indicates that the candidate has potential for the program, yet is insufficiently prepared to complete the loop. When this is the case, the candidate can repeat that specific loop, which is shown by proceeding from step 534 to step 522. This can require the candidate who is recycled be paired and/or placed within a different cohort in a different cycle.

The readiness evaluation of step 534 can also determine that the candidate is prepared, in which case the candidate attends the focus period for the loop, shown by step 536. In step 538, once the focus period is over, the candidate can participate in providing feedback for the loop, focus period, the mentors, and other candidates. In step 540, loop results can be assessed for the cohort. In step 541, the candidate's performance in the loop can be assessed. The candidate can pass, in which case credit for loop completion can be recorded and the method can proceed to step 542. Failure within a loop can result in the candidate being either disqualified (proceeding to step 548) or being recycled (proceeding to step 524 without receiving loop completion credit).

If there are additional loops in the cycle 542, the candidate can proceed to the next loop, shown by progressing to step 528. When the cycle is complete, cycle results can be assessed, as shown by step 544. An assessment of the candidate's performance can be satisfactory, in which case the candidate graduates from the program, as shown by step 546. Graduation can result in the candidate receiving a postgraduate degree. A negative assessment of the candidate's performance can result in the candidate receiving an evaluation report and not receiving the postgraduate degree, as shown by step 548.

As used herein, postgraduates are individuals who have successfully completed an undergraduate program. An undergraduate program refers to a post-secondary educational program up to the level of a bachelor's degree. Postgraduate studies include studies for earning a master's, doctorate, or professional (law and/or medical) degree. Undergraduate and postgraduate program (including program 210) can be accredited ones. Educational accreditation can be performed by membership associations that are independent of the federal or state government. Educational accreditation can be significant in that it may affect an ability to transfer credits from one school to another, to meet prerequisites established for obtaining further advanced degrees, and can affect a student's ability to obtain federal student loans.

A cohort 220 can be a group of subjects who share a particular experience during a particular time span. Specifically, a cohort 220 is a group of candidates and mentors who participate in at least one loop of a cycle of the program 210 together.

As shown herein, the various networks (e.g., network 246, networks of FIG. 2C, networks connecting data stores to computing devices) can include any hardware/software/and firmware necessary to convey data encoded within carrier waves. Data can be contained within analog or digital signals and conveyed though data or voice channels. Network can include local components and data pathways necessary for communications to be exchanged among computing device components and between integrated device components and peripheral devices. Network can also include network equipment, such as routers, data lines, hubs, and intermediary servers which together form a data network, such as the Internet. Network can also include circuit-based communication components and mobile communication components, such as telephony switches, modems, cellular communication towers, and the like. Network can include line based and/or wireless communication pathways.

Information used by the various computing components can be digitally encoded within one or more data stores (e.g., data store 242, 244, 294, 295, 296, 334, 362, etc.), which can be physical or virtual storage spaces configured to store digital information. The data stores can be physically implemented within any type of hardware including, but not limited to, a magnetic disk, an optical disk, a semiconductor memory, a digitally encoded plastic memory, a holographic memory, or any other recording medium. The data stores can be a stand-alone storage unit as well as a storage unit formed from a plurality of physical devices. Additionally, information can be stored within the data stores in a variety of manners. For example, information can be stored within a database structure or can be stored within one or more files of a file storage system, where each file may or may not be indexed for information searching purposes. Further, the data stores can utilize one or more encryption mechanisms to protect stored information from unauthorized access.

The various data elements maintained in the data stores can be managed by one or more computing devices. Further, tools, program programs, and the like can be implemented in executable software/firmware, which reside on the computing devices. The executable software/firmware can be stored on a tangible, non-transient memory capable of being executed by the computing devices.

The computing devices can include one or more processors, non-volatile memory regions, volatile memory regions, and a communication bus connecting these components. Additional components, such as network transceivers, input/output peripherals, can also be included with the computing devices. The various computing devices can operate in a stand-alone fashion and/or interoperable across a distributed computing space.

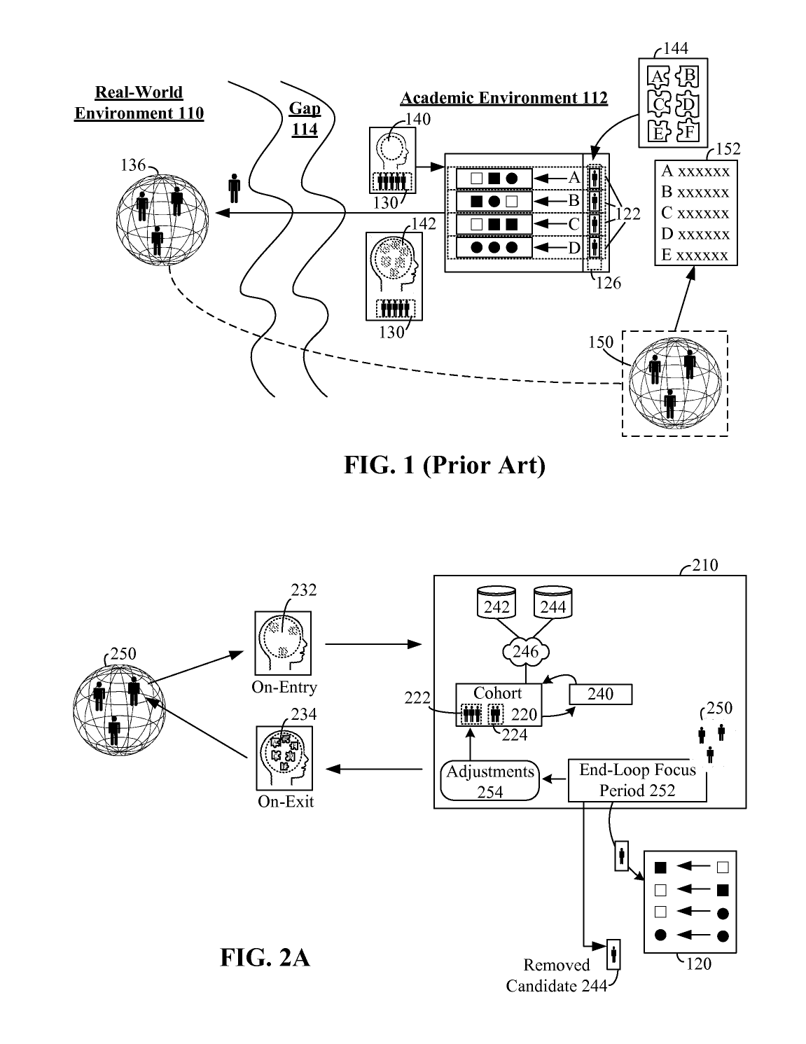

The flowchart and block diagrams in the FIGS. 1-7 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for providing postgraduate degrees comprising:
enrolling a plurality of candidates and one or more mentors in a cohort for a cycle, wherein each candidate is a human being attempting to earn a post graduate degree, wherein each mentor is a human participating with the candidates who is not eligible to earn a postgraduate degree as a result of their participation;
conducting a set of loops within the cycle;
ending each loop with a focus period, wherein the focus period is a continuous period of time that the cohort spends interacting face-to-face at a common geospatial location;
evaluating candidate performance at each loop, responsive to the evaluating:
selectively permitting a set of at least one of the candidates to continue to participate in the cycle; and
selectively not permitting a set of at least one of the candidates to continue to participate in the cycle, wherein the evaluating is performed based at least in part on candidate specific evaluation metrics provided by each of the one or more mentors; and
granting a postgraduate degree to each candidate responsive to and contingent upon successful completion of the cycle by the candidate.

2. The method of claim 1, wherein at least half of the candidates in the cohort are nontraditional students who are working full time in business within an occupation for which the postgraduate degree applies.

3. The method of claim 1, wherein said one or more mentors comprise at least one professor of a university, wherein the university is the grantor of the postgraduate degree, wherein the professor participates with the cohort for the entire cycle, and wherein the professor evaluates each candidate in the cohort at each loop and at the end of the cycle, wherein no candidate is granted the postgraduate degree without the expressed approval of the mentor(s).

4. The method of claim 3, where the university has at least one fixed geospatial location at which classes are conducted through which the university grants undergraduate degrees, wherein the common geospatial locations at which the focus periods for the loops occur are geospatial locations remote from at least one fixed geospatial locations.

5. The method of claim 1, wherein the geospatial locations at which the focus periods are conducted and the timing of the focus periods correspond to a real world location and event relevant to a case study that the corresponding loop focuses upon.

6. The method of claim 3, wherein at least one of the mentors is an adjunct mentor who is a business professional working full time in a field for which the post graduate degree applies, wherein the adjunct mentor is not employed in a permanent capacity by the university, wherein the adjunct mentor attends at least one focus period for at least one loop, wherein the adjunct mentor participates with the other mentors and the candidates during the focus period and provides feedback for evaluating candidate performance within the loop that the adjunct mentor participates within.

7. The method of claim 1, wherein a cycle consists of at least three loops and no more than five loops, which are conducted sequentially, wherein successful completion of each earlier loop is a prerequisite for each of the candidates continuing to subsequent ones of the later loops, wherein the granting of the degree to one of the candidates is contingent upon successful completion of each of the loops.

8. The method of claim 1, wherein the postgraduate degree is an accredited degree program, wherein a requirement imposed by an accreditation body for earning the accredited degree is that candidates spend at least X amount of face-to-face teaching time with an accredited professor, where at least one of the mentors is the accredited professor, wherein at least seventy five percent of the X amount of face-to-face teaching time occurs during the focus periods of the loops.

9. The method of claim 1, wherein each cycle has an established cycle begin and a cycle end time, wherein different cycles sponsored by a university that grants the postgraduate degrees have asynchronous start and end times, which are contingent upon specifics of the cohorts participating within the cycles.

10. The method of claim 1, further comprising:
wherein each candidate supplies credentials to the university before participating in a cycle, wherein the credentials of each candidate target that candidate's strengths and weaknesses in context of the field of study for which that candidate is attempting to earn a postgraduate degree; and
wherein the one or more mentors establish members of the cohort by selecting candidates having complementary strengths and weaknesses to ensure that candidates within a cohort are able to learn significantly from one another during the cycle.

11. The method of claim 1, further comprising:
evaluating performance of the cohort within the loop at the end of each loop, wherein the evaluating is based at least in part upon feedback provided by the one or more mentors;
establishing a maximum quantity of candidates within the loop able to successfully complete the loop, where the maximum quantity of candidates is less the total number of candidates participating in the loop, and where the maximum quantity of candidates varies in proportion to the evaluated performance of the cohort.

12. The method of claim 1, further comprising:
receiving feedback from each of the candidates and from the one or more mentors pertaining to performance of the candidates within each loop and within the cycle;
ranking performance of each of the candidates within each loop and within each cycle using the received feedback; and
imposing a curve within at least one of the loops, where the curve imposes a maximum number of candidates able to successful complete the loop, wherein the imposed maximum number of candidates is always less than the total number of candidates participating within the corresponding loop, wherein a performance of each candidate relative to the imposed curve for each loop is based on the ranking.

13. The method of claim 3, wherein the mentors in the cohort comprise a cross disciplinary team of professors employed by the university.

14. The method of claim 1, further comprising:
assigning self-learning tasks tailored for each candidate for each loop, wherein successful completion of the self-learning tasks is a prerequisite for permitting the corresponding candidate to participate in the focus period for that loop, wherein successful completion of the self-learning tasks is determined at least in part by the one or more mentors.

15. The method of claim 1, further comprising:
establishing a cycle repository of computing resources to be shared by the candidates and mentors in the cohort for performance of tasks within the loops or cycle.

16. The method of claim 3, further comprising:
receiving candidate feedback during each loop and cycle from the candidates regarding the performance of the one or more mentors; and
the university determining of the one or more mentors in future cycles based at least in part upon the candidate feedback.

17. The method of claim 1, further comprising:
receiving at least one case study of a real world problem from a company that is seeking a solution for the real world problem;
for at least one of the loops in the cycle, focusing the cohort on resolving or evaluating the real world problem for the company; and
wherein the focus period for the loop focused on the real world problem is performed at a site relevant to the real world problem and at a time relevant to the real world problem.

18. A computer program product for assisting with the providing of postgraduate degrees, said computer program product comprising a computer readable storage medium having computer usable program code embodied therewith, the computer usable program code comprising:
computer usable program code stored in a tangible storage medium operable to enroll a plurality of candidates and one or more mentors in a cohort for a cycle, wherein each candidate is a human being attempting to earn a post graduate degree, wherein each mentor is a human participating with the candidates who is not eligible to earn a postgraduate degree as a result of their participation;
computer usable program code stored in a tangible storage medium operable to conduct a set of loops within the cycle;
computer usable program code stored in a tangible storage medium operable to end each loop with a focus period, wherein the focus period is a continuous period of time that the cohort spends interacting face-to-face at a common geospatial location;
computer usable program code stored in a tangible storage medium operable to evaluate candidate performance at each loop, responsive to the evaluating:
computer usable program code selectively permitting a set of at least one the candidates to continue to participate in the cycle; and
computer usable program code selectively not permitting a set of at least one of the candidates to continue to participate in the cycle, wherein the evaluating is performed based at least in part on candidate specific evaluation metrics provided by each of the one or more mentors; and
computer usable program code stored in a tangible storage medium operable to grant a postgraduate degree to each candidate responsive to and contingent upon successful completion of the cycle by the candidate.

19. A system for providing post graduate degrees comprising:
a processor for executing instructions of computer program products;
a nonvolatile memory;
a volatile memory;
a bus connecting said processor, nonvolatile memory and volatile memory; and
at least one computer program product stored on the nonvolatile memory and executable by the processor, wherein instructions while a state of variables are maintained in the volatile memory as the processor executes the computer program products, wherein said system maintains records for at least a postgraduate degree granting program, wherein executing said at least one computer program products causes the system to:
enroll a plurality of candidates and one or more mentors in a cohort for a cycle, wherein each candidate is a human being attempting to earn a post graduate degree, wherein each mentor is a human participating with the candidates who is not eligible to earn a postgraduate degree as a result of their participation;
conduct a set of loops within the cycle;
end each loop with a focus period, wherein the focus period is a continuous period of time that the cohort spends interacting face-to-face at a common geospatial location;
evaluate candidate performance at each loop, responsive to the evaluating:
selectively permitting a set of at least one the candidates to continue to participate in the cycle; and
selectively not permitting a set of at least one of the candidates to continue to participate in the cycle, wherein the evaluating is performed based at least in part on candidate specific evaluation metrics provided by each of the one or more mentors; and
grant a postgraduate degree to each candidate responsive to and contingent upon successful completion of the cycle by the candidate.
